(19) United States
(12) Patent Application Publication
(10) Pub. No.: US 2006/0168822 A1
(43) Pub. Date: Aug. 3, 2006

(54) Bearing aligned scissors

(76) Inventor: Perry Kaye, Davie, FL (US)

Correspondence Address: LOCKE LIDDELL & SAPP LLP;ATTN: STACIE COX, 2200 ROSS AVENUE, SUITE 2200, DALLAS, TX, 75201-6776, US

(21) Appl. No.: 11/049,113

(22) Filed: Feb. 2, 2005

(51) Int. Cl. B26B 13/28

(52) U.S. Cl. 30/266; 30/341

(57) ABSTRACT

A scissors includes first and second blades, each blade having a handle and a cutting edge, an inner surface and an outer surface. The first blade inner surface includes a boss disposed between the handle and the cutting edge and extending outwardly from the inner surface. A bearing raceway is circumferentially disposed around the boss. The second blade inner surface includes a circular recess disposed between the handle and the cutting edge. The recess receives the boss of the first blade. The circular recess includes a circumferentially disposed bearing raceway. A pluralities of ball bearings are disposed within the circular recess bearing raceway and the boss bearing raceway for pivotally coupling set first and second blades members.

### TECHNICAL FIELD OF THE INVENTION

The present invention relates generally to scissors assemblies, and more particularly to a bearing aligned scissors.

### BACKGROUND OF THE INVENTION

Scissors, sheers and pliers are common tools that have been used for hundreds of years and are still used today. These tools have many advantages such as being portable, easy to use and inexpensive to manufacture. These tools, in their most basic form, are made of three basic elements; a top work surface assembly, a bottom work surface assemble and a shaft to join the two assemblies. The shaft in this type of tool acts as a fulcrum about which rotational work forces are exerted and also acts as an assembly structural component, with side or thrust force, to keep the two work surface assemblies in an aligned position. Lower quality tools use a simple rivet as the shaft. In all of these tools, the assemblies contact the surface of the shaft and the sides of the work surface assemblies adjacent the shaft. Higher quality tools use various configurations of shafts, such as screws and nuts, and combine these fasteners to allow these tools to be adjusted to align the two work surface assemblies as the assemblies go out of alignment about the shaft and/or with respect to each other.

The shafts, about which the two scissors' work surface assemblies are joined, cause many problems with the performance and longevity of the tool. A simple rivet joined scissors will operate for some time after being manufactured. Because all of the elements slide against each other this type of configuration has friction points at the shaft and between the two work surface assemblies. With use, over time, a rivet assembled scissors' performance will degrade, due to wear at the rivet, between the work surface assemblies and their joining holes through which the assemblies are attached to the rivet.

To lessen the problems involved with a rivet assembled scissors, many scissors are made with an adjustable screw that allows the user to increase or decrease the thrust force, parallel to the screw, to allow the scissors to have a tighter or looser feel and also to allow the shaft to be cleaned or changed if necessary. The sides of the work surface assemblies can also be cleaned by allowing the scissor to be disassembled.

To make the screw based scissors perform even better many innovations have been made that use ball bearings to lower friction and lessen wear at the shaft and against the sides of the work surface assemblies where the assemblies touch at the point they are joined by the shaft.

However, design deficiencies still cause scissors to eventually perform poorly and require adjustment. If the wear is sever enough the scissors are discarded. Wear of contacting work surfaces causes scissors to move out of alignment and often loosens the retaining nut holding the work surface assemblies on the shaft. This condition causes the scissors' performance to degrade over time and with use.

A problem with current scissor designs is that the work shaft is perpendicular to the rotational work forces being applied. Because the two work surface assemblies rotate in opposite directions, one assembly is always applying pressure in the opposite direction and at the opposing end of the shaft; i.e. one force pushes the shaft down while the other is pushing it up. This see-saw force effect, among other things, creates friction, wear and can also work against the task at hand.

For scissors to cut easily the scissor blades are often made with a relief grind that shapes the blades so the blades crossover each other. This shape insures that the blade edges are always in contact, and with pressure against each other, at the point that cutting takes place. If the pressure, with which the blades are pressed against each other, is not great enough then, instead of cutting the material, the material will slip between the blades. The cut pressure, at the point that cutting takes place, must be applied by the user or by the joining mechanism, relief grind or a combination thereof. This force is another force, placed on the shaft, which creates performance and wear problems.

In addition to the point at which the scissor or sheer perform their work, where contact of the top work surface assembly and bottom work surface assembly are required, other points of contact usually only add friction. The basic scissor design, with a shaft as the main fulcrum for both work assemblies, is the conventional way to make scissors, sheers and pliers. However the shaft not only creates a fulcrum about which to work it also creates several surfaces that slide together during use and these surfaces are susceptible to friction and wear. Wear on the shaft, and the holes through which the work surface assemblies are mounted to the shaft can cause the tool to perform poorly and eventually degrade over time.

A need has thus arisen for an improved scissors.

### SUMMARY OF THE INVENTION

In accordance with the present invention, a scissors includes first and second blades, each blade having a handle and a cutting edge, an inner surface and an outer surface. The first blade inner surface includes a boss disposed between the handle and the cutting edge and extending outwardly from the inner surface. A bearing raceway is circumferentially disposed around the boss. The second blade inner surface includes a circular recess disposed between the handle and the cutting edge. The recess receives the boss of the first blade. The circular recess includes a circumferentially disposed bearing raceway. A pluralities of ball bearings are disposed within the circular recess bearing raceway and the boss bearing raceway for pivotally coupling the first and second blades.

### BRIEF DESCRIPTION OF THE DRAWINGS

For a more complete understanding of the present invention and for further advantages thereof, reference is now made to the following Description of the Preferred Embodiments taken in conjunction with the accompanying Drawings in which:

FIG. 1 is a front plan view of the present scissors;

FIG. 2 is a rear plan view of the present scissors;

FIG. 3 is an exploded perspective view of the present scissors;

FIG. 4 is an exploded perspective view of an additional embodiment of the present scissors;

FIG. 5 is an exploded perspective view of an additional embodiment of the present scissors;

FIG. 6 is a front plan view of the assembled scissors shown in FIG. 5; and

FIG. 7 is a sectional view of the assembled scissors taken generally along sectional lines 7-7 of FIG. 5.

### DESCRIPTION OF THE PREFERRED EMBODIMENTS

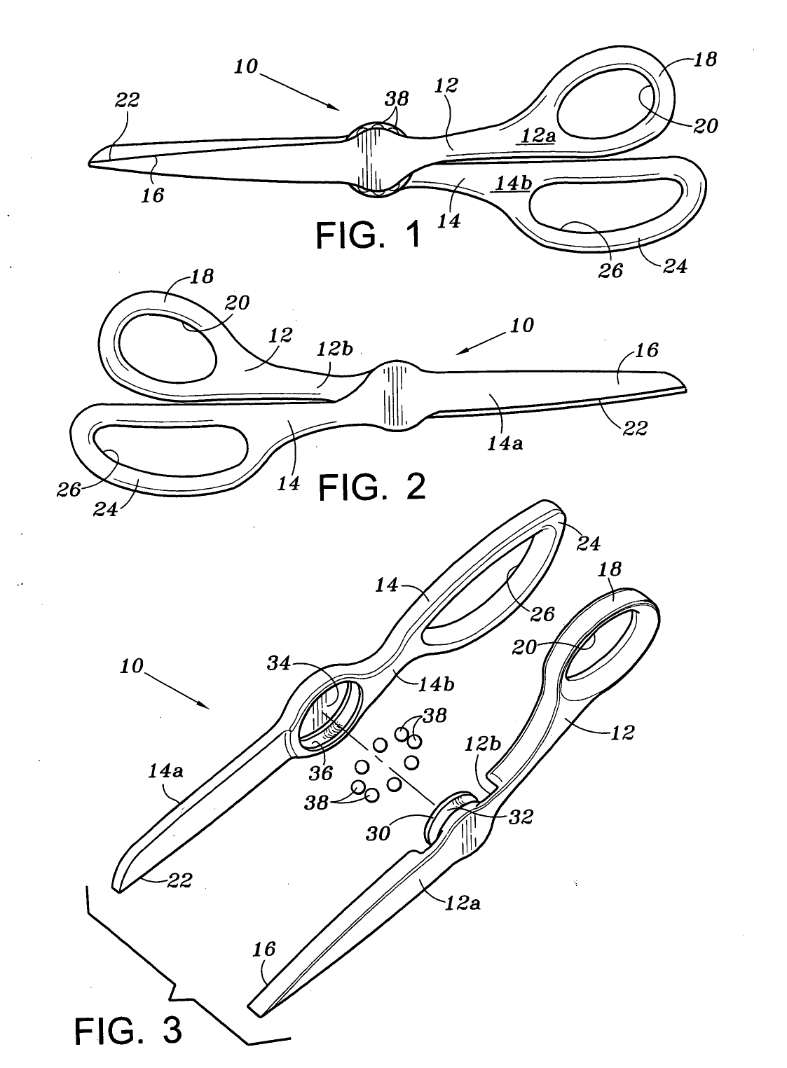

Referring simultaneously to FIGS. 1, 2 and 3, the present scissors is illustrated, and is generally identified by the numeral 10. Scissors 10 includes a first blade member 12 and a second blade member 14. Blade member 12 includes a cutting edge 16 and a handle 18. Handle 18 includes a thumb aperture 20. Blade member 12 further includes an outer surface 12a and an inner surface 12b.

Blade member 14 includes a cutting edge 22 and a handle 24. Handle 24 includes a finger aperture 26. Blade member 14 further includes an outer surface 14a and an inner surface 14b.

As more clearly shown in FIG. 3, blade member 12 includes a boss 30 disposed between cutting edge 16 and handle 18 and extending outwardly of inner surface 12b. Boss 30 includes a circumferentially disposed bearing raceway 32.

Blade member 14 includes a circular recess 34 disposed between cutting edge 22 and handle 24. Boss 30 is received by circular recess 34 when blade members 12 and 14 are assembled. Circular recess 34 includes a circumferentially disposed bearing raceway 36.

Disposed within a bearing raceways 32 and 36 are plurality of ball bearings 38. Ball bearings 38 may be placed within bearing raceway 36. Subsequently, boss 30 is inserted into circular recess 34 such that bearings 38 become positioned within bearing raceway 32 of boss 30. Ball bearing 38 function to couple blade members 12 and 14 and also allows blade members 12 and 14 to pivot for scissors cutting action.

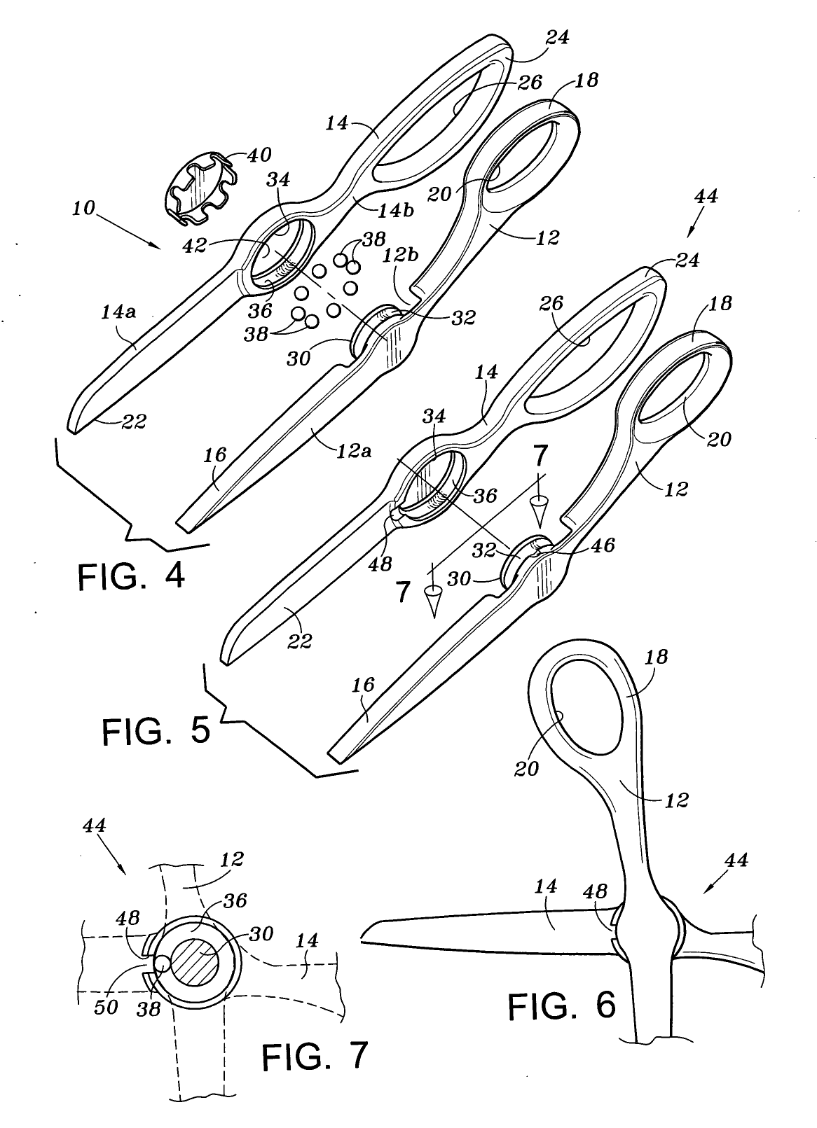

A bearing cage 40 (FIG. 4) may be positioned through an aperture 42 within circular recess 34. Cage 40 maintains bearings 38 in a spaced apart relationship in bearing raceways 32 and 36.

There are several methods to assemble blade members 12 and 14. The following are illustrative. An assembly method involves placing ball bearings 38 into raceway 36 so the ball bearings 38 pool to the bottom of raceway 36. Boss 30 is then inserted at the top of raceway 36 without disturbing the ball bearings 38. Boss 30, once in position, is then pressed toward the ball bearings 38, such that the ball bearings 38 are contained between raceways 36 and 32. The ball bearings 38 are then moved around raceways 36 and 32, which lock the members 12 and 14 into position. Cage 40 is then added to keep the ball bearings 38 spaced apart. Once completed the blade member 12 and 14 are set to a specific and advantageous alignment and are biased to perform work at this advantageous alignment.

Different types of cages 40 can be used as different types, sizes, styles and materials of ball bearings. The cage 40 can be made out of plastic and snapped together so it fits around the circumference of the ball bearings 38. A conventional bearing cage can also be used in other embodiments.

Referring to FIGS. 5, 6 and 7, an additional embodiment of the present scissors is illustrated, and is generally identified by the numeral 44. Scissors 44 uses an assembly method without cage 40 but instead fills the space between the raceways 36 and 32 with a full compliment of bearings 38. Blade member 12 includes a slot 46 in communication with raceway 32. Blade member 14 includes a slot 48 in communication with raceway 36. In this assembly method the blade members 12 and 14 of scissors 44 are assembled by orienting them such that slots 46 and 48 align to create an aperture 50 to allow individual bearings 38 to be inserted through aperture 50 into the raceways 36 and 32. (FIGS. 6 and 7) As more bearings 38 are inserted through aperture 50 the blade members 12 and 14 align. Bearing raceway 32 is centered and aligned in all axis and the correct distance and orientation to bearing raceway 36. Once a full compliment of ball bearings 38, based on a number selected for the design, the blade members 12 and 14 are moved such that the slots 46 and 48 are moved out of alignment thus trapping the ball bearings 38 between bearing raceways 32 and 36. Scissors 44 allows for easy assembly and disassembly for cleaning and maintenance. Additional assembly methods are also possible.

As can be seen, the present scissors 10 utilizes bearings 38 to align blade members 12 and 14. The present invention utilizes no shaft about which blade members 12 and 14 rotate, thereby eliminating friction in the use of the present scissors 10. Blade members 12 and 14 rotate about each other with the assistance of ball bearings 38. Ball bearings 38 lessen such friction and bias blade members 12 and 14 in alignment. Bearings 38 disposed within raceways 32 and 36 eliminate the see-saw force effects present is conventional scissors between blade members. The present invention by eliminating a shaft, allows the blade members to avoid friction created by contact with a shaft and also allows a more uniform distribution of forces placed on a scissors by the user.

Bearings 38 include bearings having a variety of shapes and materials, such as, for example, solid hard rubber to allow assembly of blade members 12 and 14 and to allow scissors the added ability to slightly flex.

Other alterations and modifications of the invention will likewise become apparent to those of ordinary skill in the art upon reading the present disclosure, and it is intended that the scope of the invention disclosed herein be limited only by the broadest interpretation of the appended claims to which the inventors are legally entitled.

What is claimed is:

1. A scissors comprising:
a first blade member having a handle and a cutting edge, an inner surface and an outer surface;
a second blade member having a handle and a cutting edge, an inner surface and an outer surface;
said first blade member inner surface including a boss disposed between said handle and said cutting edge and extending outwardly from said inner surface;
a bearing raceway circumferentially disposed around said boss;
said second blade member inner surface including a circular recess disposed between said handle and said cutting edge, said circular recess being disposed for receiving said boss of said first blade member, said circular recess having a circumferentially disposed bearing raceway; and
a plurality of ball bearings disposed within said circular recess bearing raceway and said boss bearing raceway for pivotally coupling said first and second blade members.

2. The scissors of claim 1 and further including:
a bearing cage disposed within said circular recess for maintaining said plurality of bearings in a spaced apart relationship.
